(19) United States
(12) Patent Application Publication
(10) Pub. No.: US 2015/0163246 A1
(43) Pub. Date: Jun. 11, 2015

(54) SYSTEM AND METHOD FOR ACTIVATION OF PERSONAS BASED ON ACTIVATION PARAMETERS RELATED TO A MULTIPLE-PERSONA MOBILE TECHNOLOGY PLATFORM (MTP)

(71) Applicant: Cellrox, Ltd., Tel Aviv (IL)

(72) Inventor: Oren LAADAN, New York, NY (US)

(73) Assignee: Cellrox, Ltd., Tel Aviv (IL)

(21) Appl. No.: 14/560,958

(22) Filed: Dec. 4, 2014

Related U.S. Application Data
(60) Provisional application No. 61/912,048, filed on Dec. 5, 2013.

(51) Int. Cl. H04L 29/06

(52) U.S. Cl. CPC H04L 63/20

(57) ABSTRACT

A method, user terminal, and server are provided for activating a persona in a multiple-persona mobile technology platform (MTP). The method includes receiving at least one activation parameter value respective of the MTP; retrieving at least one activation rule defining at least one activation condition and at least one action to be performed on at least one persona of the multiple-persona of the MTP; analyzing the at least one received activation parameter value to determine the if the at least one activation condition has been met; and, upon determining that the at least one activation condition has been satisfied, applying the at least one action defined in the satisfied activation condition on the at least one persona.

### CROSS-REFERENCE TO RELATED APPLICATIONS

This application claims the benefit of U.S. Provisional Application No. 61/912,048 filed on Dec. 5, 2013, the contents of which are hereby incorporated by reference.

### TECHNICAL FIELD

The present invention relates generally to multiple-persona mobile technology platforms (MTPs), and more specifically to systems and methods for enabling access to and/or activating a persona based on activation parameters related to an MTP.

### BACKGROUND

With the advance of modern mobile technology, people carry mobile devices with them wherever they go. A mobile technology platform, such as, a mobile device is used today for a variety of forms of communication such as calls, email correspondence, chats, and so on. These forms of communication may be performed not only by a single entity, but also by different personas executed on the same mobile device, depending on a user's needs. In a case where multiple personas may be executed on the same mobile device, each persona is associated with and attributes a unique set of the user's preferences.

Different personas may have different sets of restrictions and/or functionalities determined respective of the type of information and applications accessible through such personas. For example, one persona may be authorized to perform certain actions while another persona may be authorized to perform other actions. As another example, a “finance persona” may be configured to allow a trading application to trade stocks online while a “kids personal” may block any access to such application. To this end, having multiple personas on the same mobile device enhances the user experience by providing access to different applications and/or different preferences for such applications installed on the mobile device based on the user's given needs.

Moreover, having multiple personas executed on the same mobile device allows the user to secure information and/or separate certain functionalities. As an example, a personal persona grants a user access to personal information such as, for example, family contact list. A work persona allows the user of the mobile device to perform work related actions such as, for example, accessing an enterprise's secure information, accessing work-related email inboxes, and so on.

Switching between personas should be secure. The security level of accessing a persona should be set respective of the type of information and applications accessible through the personas. In addition, it would be advantageous if switching between personas will be performed with respect to the functionality of a persona. As an example, a switch to a “finance persona” should occur immediately when the stock price of a stock on a watch list is dropped.

Currently there is not a solution that allows secure or otherwise functionality-based activation of a persona. At best, currently users can proactively select a persona that they wish to activate.

It would therefore be advantageous to provide a solution that would enable the activation of personas based on at least their respective security level and functionality.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later. For convenience, the term some embodiments may be used herein to refer to a single embodiment or multiple embodiments of the disclosure.

Certain exemplary embodiments include a method for activating a persona in a multiple-persona mobile technology platform (MTP). The method comprises receiving at least one activation parameter value respective of the MTP; retrieving at least one activation rule defining at least one activation condition and at least one action to be performed on at least one persona of the multiple-persona of the MTP; analyzing the at least one received activation parameter value to determine the if the at least one activation condition has been met; and upon determining that the at least one activation condition has been satisfied, applying the at least one action defined in the satisfied activation condition on the at least one persona.

Certain exemplary embodiments also include a user terminal for activating a persona of a multiple-persona configured on a mobile technology platform (MTP). The terminal comprises a user interface; a processing unit; and a memory, the memory containing instructions that, when executed by the processing unit, configure the terminal to: receive at least one activation parameter value respective of the MTP; retrieve at least one activation rule defining at least one activation condition and at least one action to be performed on at least one persona of the multiple-persona of the MTP; analyze the at least one received activation parameter value to determine the if the at least one activation condition has been met; and upon determination that the at least one activation condition has been satisfied, applying the at least one action defined in the satisfied activation condition on the at least one persona.

Certain exemplary embodiments also include a server for activating a persona of a multiple-persona configured on a mobile technology platform (MTP). The server comprises a processing unit; and a memory, the memory containing instructions that, when executed by the processing unit, configure the server to: receive at least one activation parameter value respective of the MTP; retrieve at least one activation rule defining at least one activation condition and at least one action to be performed on at least one persona of the multiple-persona of the MTP; analyze the at least one received activation parameter value to determine the if the at least one activation condition has been met; and upon determination that the at least one activation condition has been satisfied, enforcing the at least one action defined in the satisfied activation condition on the at least one persona.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic diagram of a network system utilized for describing the various disclosed embodiments;

FIG. 2 is a flowchart illustrating a method for activating a persona in a MTP according to an embodiment; and

FIG. 3 is a flowchart illustrating a method for analyzing activation conditions to determine activation parameters required to be held to apply an action on a persona of a MTP according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for activating a persona in a multiple persona mobile technology platform (MTP) based on activation parameters related to the MTP. An activation of a persona relates to an action to be applied on the persona upon satisfying at least one activation rule. The activation rule defines at least one activation condition and at least one action. The condition is defined with respect to one or more activation parameters. An activation action defined in the rule may include, but is not limited, switch to/from a persona, create/destroy the persona, activate/deactivate the persona, download/delete the persona, lock/unlock the persona, block/unblock the persona, enable/disable certain features or capabilities of a persona, and so on. It should be noted that the action on a persona may be performed automatically without any input or command provided by a user of the MTP.

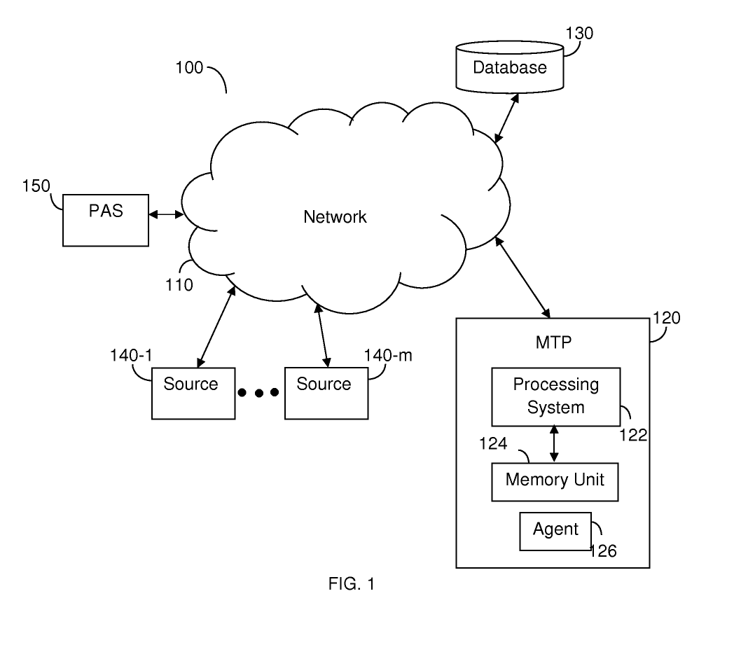

FIG. 1 shows an exemplary and non-limiting schematic diagram of a network system 100 utilized for describing the various disclosed embodiments. A network 110 is communicatively connected to a MTP 120, a database 130, a plurality of sources 140-1 through 140-n (hereinafter referred to individually as a source 140 and collectively as sources 140) and at least one persona activation server (PAS) 150. The network 110 may be, but is not limited to, a local area network (LAN), a wide area network (WAN), a metro area network (MAN), the worldwide web (WWW), the Internet, implemented as wired and/or wireless networks, and any combinations thereof.

The MTP 120 that is communicatively connected to the network 110. The MTP 120 is configured to execute a plurality of personas thereon. A persona is defined with a unique set of user preferences associated with a respective persona. A persona refers to at least one role or identity associated with and assumable by a user of the MTP 120. The roles or identities of the user correspond to a unique execution environment. The execution environment may be a virtual execution environment, an operating system, a sandbox, a userspace container, a hypervisor or any combination thereof. Each persona is associated with a unique set of metadata.

In an embodiment, a persona is a user profile defined as part of an operating system supporting multiple-user feature in the MTP. Such a user profile is maintained and monitored by the MTP's operating system and allows to define under each profile a set of specific applications (apps), passwords, and other lock mechanisms associated with a specific user of the profile. For example, one user profile will be set for the owner of the MTP where all applications are available and another profile for a child using the MTP where only games may be available.

The MTP 120 typically comprises a processing system 122 and a memory unit 124. The memory unit 124 includes a plurality of instructions that can be executed by the processing system 122 to at least perform the various embodiments disclosed herein. The processing system 122 may comprise or be a component of a larger processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. The processing system 122 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system 122 to perform the various functions described herein.

The MTP 120 may be, but is not limited to, a cellular phone, a smart phone, a tablet device, a notebook computer, a laptop, an in-vehicle infotainment system (IVI), a wearable computing device, a set-top box, a smart TV, and the like. The MTP 120 further comprises an agent 126 installed therein. The agent 126 may be executable code that is stored in the memory unit 124 and executed by the processing system 122. Alternatively to the agent 126, a script that is supported by an operating system (OS) of the MTP 120 may be used.

The database 130 is used to maintain information related to the MTP 120. The database 130 may be part of the MTP 120 or connected thereto as an external component. In certain embodiments, the database 130 may include a unique set of the user's preferences associated with each persona of the multiple personas executed through the MTP 120, activation rules related to each persona of the multiple personas, and so on. In an embodiment, the information maintained in the database 130 can be also stored in the memory unit 124 of the MTP 120.

According to an embodiment, the agent 126 is communicatively connected to the PAS 150 via the network 110. According to an embodiment, the agent 126 is configured to receive and/or collect activation parameters and/or activation actions from the PAS 150 (e.g., sports news, currency exchange rate index), the sources 140, the network 110, internet, hardware of the MTP 120, system of the MTP, and so on.

Each one of the sources 140 may be, for example, a proximity sensor, a light sensor, a sound sensor, a temperature sensor, a global positioning system (GPS), a compass, and so on. Each source 140 is configured to identify at least one activation parameter related to the MTP 120. It should be noted that each source 140 may be communicatively connected to the MTP 120 or integrated in the MTP 120.

The activation parameters are defined as any parameters related to the MTP 120, for example, environmental parameters, hardware parameters, system parameters (e.g., the state of a lock screen of the MTP 120), network parameters, user behavioral parameters (e.g., the user's browsing habits via accounts or via cookies), aggregated data, time series-based data, and so on.

The environmental parameters are parameters related to the environment in which the MTP 120 is found. Such environmental parameters may include a temperature, a time of an attempted access, location of the MTP 120, time information associated with the location, proximity of the MTP 120 to one or more objects, level of environmental light, level of environmental sound, and so on. The system parameters can be derived through an OS of the MTP 120. Such system parameters may be related to status of the software resources of the MTP 120. The network parameters may be, but are not limited to, data traffic, connectivity type, current active network connection, settings of the MTP 120 (e.g., network settings), and the like. The hardware parameters include information about the hardware resources of the MTP 120. Such hardware parameters may include, presence of near-field communication (NFC) signal, device, or a peer, network in proximity, state of Bluetooth®, and so on.

Each activation parameter related to the MTP 120 is analyzed to identify at least one condition required for applying an action on a persona of the multiple personas of the MTP 120. It should be noted that the at least one condition may be a simple condition or a compound condition. A simple condition can be met by a single parameter, while a compound condition can combine multiple simple conditions to be satisfied. The simple and compound conditions are collectively referred to as “activation conditions.” The activation conditions and thereby the set of activation parameters to be tested may be different from persona to persona and typically determined by, for example, the security level, the functionality of the MTP, and so on.

In an embodiment, the activation condition is part of an activation rule which defines which action to take if the activation condition is satisfied. In an exemplary embodiment, an activation rule is denoted as follows:
if [activation condition≡input] then apply [action] on [personaₓ]

An activation condition may be a simple or compound condition and is defined with respect to one or more activation parameters. An action may be one or a series of actions to be applied on a personaₓ. The personaₓ is one of the multiple personas defined in the MTP. The activation rules may be configured or otherwise provided, for example, by information technology (IT) personnel, a security policy, the PAS 150, or a user of the MTP 120 as part of the user's preferences. The user's preferences associated with each persona are retrieved from the database 130, received from the PAS 150, or stored in memory unit 124 of the MTP 120. The action to apply may be, but is not limited to, switch to/from a persona, create/destroy the persona, activate/deactivate the persona, download/delete the persona, lock/unlock the persona, block/unblock the persona, enable/disable features of the persona (e.g., enable to access a contact list), enable/disable services externally provided to the MTP 120.

When an activation rule required for applying at least one action on a persona is satisfied, the user may be notified respective thereof. This may occur, for example, by displaying a notification on a display of MTP 120, outputting an audio signal by using a speaker of the MTP 120, a visual indication (e.g., using a LED indication), sending an email or a text message to the MTP 120, and projecting to a remote display via, for example, Miracast® protocol.

In an exemplary and non-limiting embodiment, the user may be requested to confirm the activation action on the persona, e.g., by providing a notification or through any other means. It should be emphasized that the activation action may be applied automatically without notifying the user. In an embodiment when more than one action rule is met, a selection process, discussed below, will select at least one rule to operate on.

According to one embodiment the activation rules may be evaluated periodically, upon a predefined trigger, or upon a user demand. As an example, by identifying on Sunday morning that the geo-location of the MTP 120 is in Paris, a notification indicating the option to create a persona that may be enabled within Paris with information and functionality related to Paris is provided to the user. According to this example, by identifying on Monday that the geo-location of the MTP 120 is back in NYC, a switch to a “home persona” is performed. Another activation rule would define an action to destroy the Paris persona when the MTP 120 location is in NYC.

As a non-limiting example for the operation of the agent 126, a set of activation rules related to the permissions privacy information required for an activation of a work persona are stored in the MTP 120 or otherwise provided by the PAS 150. For instance, such activation rules define that the user must be working from a military base (first activation condition) during the night (second activation condition) to activate a business persona. Activation parameters related to the MTP 120 are identified (in this example, the MTP 120 is located in a military base at local night time) and analyzed respective thereof. It is determined that the activation conditions (defining the required location and time) are met, access to the work environment of the MTP 120 is provided and the work persona is activated respective thereof.

As another non-limiting example, the agent 126 is configured to retrieve from the database 130 activation rules related to a sport persona and the activation conditions required for an activation of such sport persona. For example, the activation conditions are: “World Cup games” (first activation condition) and “Matches that Brazil plays in” (second activation condition). Upon receiving the result of a soccer match (first activation parameter) between Argentina and Brazil (second activation parameter) from a sports server communicatively connected to the MTP 120 through the network 110, the activation parameters are analyzed and it is determined that the activation conditions are met. The sport persona is activated respective thereof.

It should be noted that the process of processing, creating, collecting activation parameters, and applying actions can be performed by the PAS 150. Specifically, the PAS 150 is configured to collect data related to activation parameters and provide such data to the MTP 120. That is, the PAS 150 provides activation parameters collection service to the MTP 120 and/or the agent 126. In addition, the PAS 150 is configured to evaluate activation rules, continuously, periodically, or on demand. The action to be performed in a response to a satisfied activation rule is communicated to the PAS 150.

In an embodiment, the PAS 150 can also apply an activation action on a persona in response to a rule evaluated either by the PAS 150 or MTP 120. For example, the PAS 150 can deny access to corporate resources (email, calendar, contacts, network, etc.) on a personal persona, kid's persona, or other non-work personas.

The PAS 150 is further configured to create or otherwise suggest activation rules that can be useful for security or for functionality. New activation rules may be suggested based on the user behavior or location, new services/personas that become available over time, or based on predefined event. For example, a cybersecurity alert is issued, then the PAS 150 may suggest a rule that is tailored to that alert to implement extra security measures that are otherwise not part of the security policy.

It should be noted that the PAS 150 may be realized through a plurality of virtual or physical computing machines.

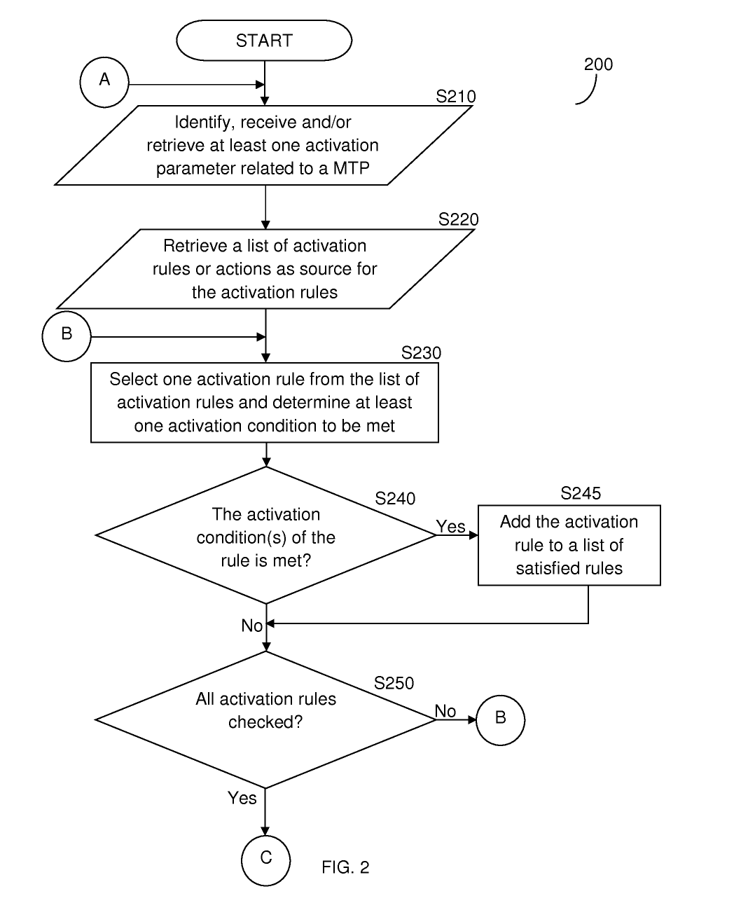

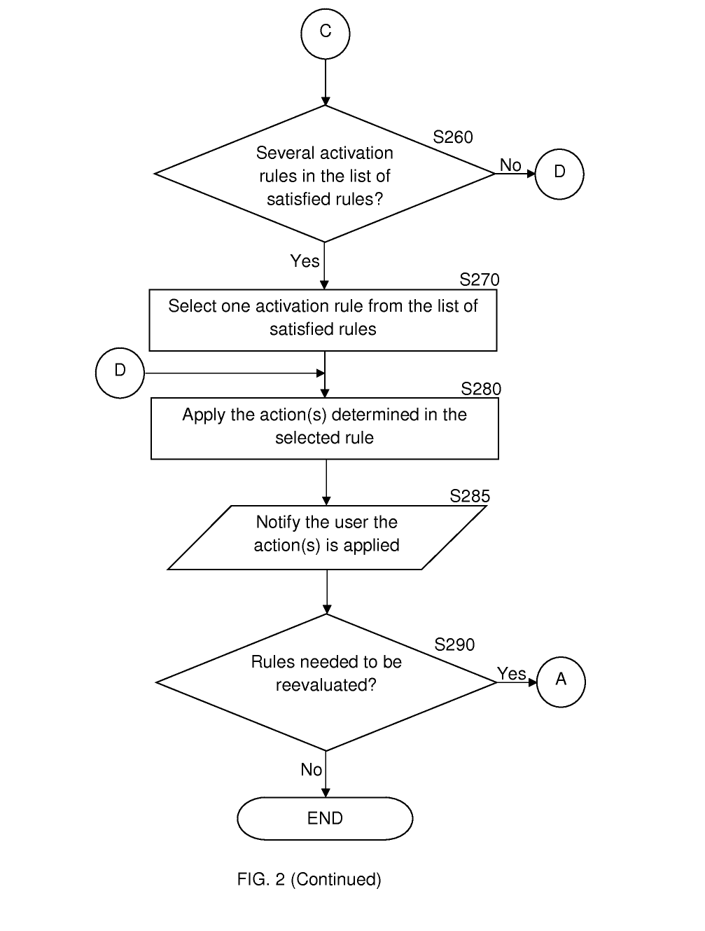

FIG. 2 shows an exemplary and non-limiting flowchart 200 describing a method for applying actions on a persona of a multiple-persona of an MTP according to an embodiment. To this end, at least one activation rule is defined using an activation condition and at least one action to be applied on at least one persona. That is, an activation condition is defined using at least one activation parameter (e.g., environmental, system, communication, hardware parameters, etc.). The activation condition is met when activation parameters' values meet predefined values. The action applied may be, but is not limited to, switch to/from a persona, create/destroy the persona, activate/deactivate the persona, download/delete the persona, lock/unlock the persona, block/unblock the persona, enable/disable features of the persona (e.g., enable to access a contact list), or enable/disable services provided by a remote server (e.g., server 150) communicatively connected to the MTP (e.g., MTP 120).

The activation rules for at least one persona may be configured, for example, by information technology (IT) personnel, a policy of the OS of the MTP, the PAS 150, or a user of the MTP, based on activation parameters or based on a trigger (e.g., action). The activation conditions and rules may be set, for example, according to a security level of a persona or according to the functionality of the MTP (e.g., switch to “Paris persona” when landing in Paris, switch to “education persona” when arriving to school). The security level of the persona and/or the functionality of such persona (or the MTP) can be set based on the unique set of user's preferences associated with the persona and a security policy associated with the persona.

In S210, at least one activation parameter related to the MTP is identified, for example, by one or more sources (e.g., one or more of the sources 140). Activation parameters may also be collected from the network (e.g., network 110), from the internet, from the hardware of the MTP and from the user behavior. In an embodiment, the activation parameter(s) may be retrieved from a database (e.g., the database 130). In another embodiment, the activation parameter(s) related to the MTP may be received and/or collected by an agent (e.g., the agent 126) that is installed on the MTP 12-. In yet another embodiment, the activation parameter(s) related to the MTP 120 may be received and/or collected by the remote server communicatively connected to the MTP 120 through the network. The activation parameter(s) may include environmental parameters, system parameters, hardware parameters, parameters related to the network, parameters related to the behavior of the user when using the MTP, aggregated data, time series-based data, etc., as further described above with reference to FIG. 1.

In S220, a list of activation rules is retrieved. In S230, one activation rule from the list of activation rules is selected and at least one activation condition required to be met respective of the activation rule is determined. In S240, it is checked whether the at least one activation condition is satisfied and, if so execution continues with S245; otherwise, execution continues with S250. In S245, the satisfied activation rule is added to a list of satisfied rules and then execution continues with S250. The list of satisfied rules may be stored in the database 130 and/or in the memory of the MTP (e.g., memory unit 124).

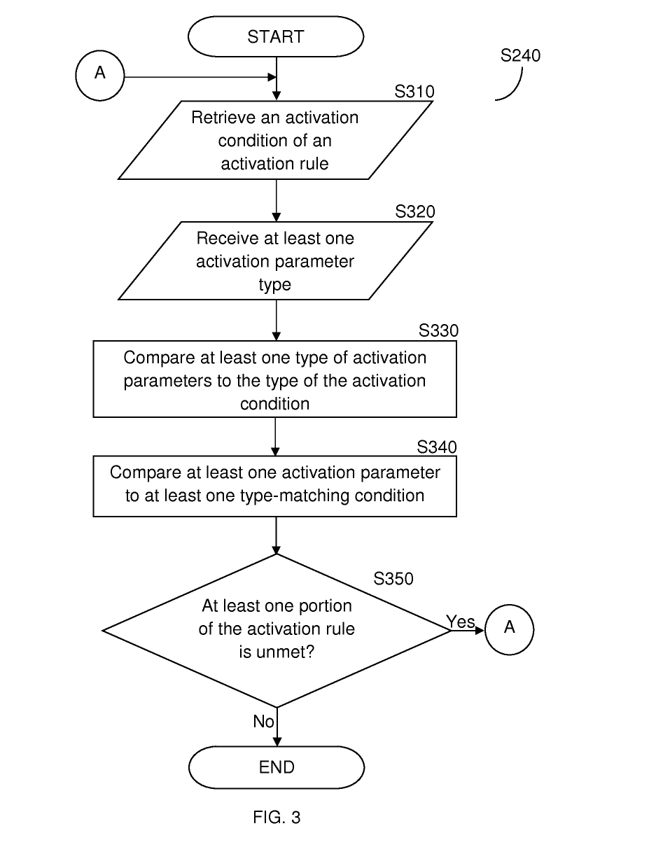

It should be noted that in S240 the at least one activation condition is analyzed to determine which activation parameter(s) the at least one activation condition is associated with. The at least one activation condition may be a simple condition or a compound condition. A simple condition can be met by a single activation parameter, while a compound condition can combine multiple simple conditions to be met. Analysis of activation condition(s) to determine the activation parameters they are associated with is described further herein below with respect to FIG. 3.

In S250, it is determined whether all the activation rules have been checked and, if so, execution continues with S260; otherwise, execution returns to S230. In S260, it is checked whether there is more than one activation rule in the list of satisfied rules, and, if so, execution continues with S270; otherwise, execution continues with S280.

In S270, one activation rule is selected from the list of satisfied rules. In an embodiment, the selection is made by order (e.g., the first activation rule is applied), respective of predetermined prioritization (e.g., a prevailing activation rule is applied), a random selection, a round robin selection, and the like. The prioritization may be determined respective of the user's preferences, the policy of the OS of the MTP, and so on. In another embodiment, the activation rule may be selected by the user (e.g., prompt the user to select).

In S280, the action(s) associated with the selected activation rule is applied on the (target) persona defined in the selected rule. In optional S285, the user is notified respective of the action to be applied and the decision as to which persona(s) the action(s) will be applied to. A notification may be displayed on the display of the MTP, sounded by a speaker of the MTP, delivered by an email or by a text massage, and so on. According to an embodiment, the notification may include an option to confirm the execution of the action. According to another embodiment, the action(s) defined in the activation rule is automatically executed. The type of action(s) that may be applied on a persona are described further herein above.

In S290, it is checked whether the activation rules needed to be reevaluated (e.g., based on changes in the activation parameters and/or elapsed of predefined interval), If so, execution returns to S210; otherwise, execution terminates. It should be noted that the method described above may be performed and enforced by the agent 126 or by the PAS 150 (or any system external to the MTP 120) without derogating from the scope of the embodiments disclosed herein.

FIG. 3 is an exemplary and non-limiting flowchart S240 illustrating a process for analyzing activation conditions according to an embodiment. The analysis may be performed on a MTP (e.g., MTP 120) by an agent (e.g., agent 126) installed on the MTP or by a server (e.g., the PAS 150) communicatively connected to the MTP via the network (e.g., network 110).

In S310, a type of the activation condition of an activation rule being analyzed is retrieved, for example, from a database (e.g., database 130) and/or from a memory of the MTP (e.g., memory unit 124). The activation condition may be a simple condition or a compound condition combining multiple simple conditions required to be satisfied. The type of the activation condition is determined respective of the activation rule defining it.

The possible types of the simple activation condition are typically the same as the possible types of activation parameter. As non-limiting examples, an activation condition of “at least 50° C.” may belong to the type “temperature,” an activation condition of “30-40° N 120-130° W” may belong to the type “geographical location,” an activation condition of “within 300 feet of the Empire State Building” may belong to the type “proximity of the MTP to an object,” an activation condition of “EST” may belong to the type “time information of the location of the MTP,” and so on. It should be noted that an activation condition may also comprise any of the types activation conditions defined above with reference to FIG. 1.

In S320, at least one activation parameter is received. The activation parameter may be received from different sources as discussed in detail above. It is checked if the received activation parameter is environmental, system, network, behavioral, aggregated data, time series-based data, etc., and the quantity or measure that the parameter relates to. As non-limiting examples, an activation parameter of “70° C.” may belong to the type of environmental parameter and its measure is “temperature,” an coordinates “37° N 122° W” may belong to the type an environmental parameter with a “geographical location” measure, a proximity value of “150 feet away from the Empire State Building” is another example a type of activation parameter that may belong to the type “proximity of the MTP to an object,” an activation parameter of “EST” may belong to the type “time information of the location of the MTP,” and so on.

In S330, at least one determined type of the activation parameter is compared to at least one type of the simple activation condition to identify at least one type of the simple activation condition that matches at least one type of the activation parameter. In S340, respective of the comparison, at least one activation parameter is compared to each identified type-matching simple activation condition to identify each satisfied activation condition.

In S350, it is determined if additional activation conditions are included in the activation rule, for example, additional activation conditions included in a case of the compound condition combining multiple simple conditions are unmet. If so, execution continues with S310; otherwise, execution terminates.

As a non-limiting example, an activation parameter of “80° C.” is determined to have the type “temperature.” In this example, there is one persona on the MTP and its sole activation condition is “temperature exceeds 60° C.” The type of this activation condition is determined to be “temperature.” The activation parameter type is compared to the activation condition type to identify the type of the condition “temperature exceeds 60° C.” as matching the type of the activation parameter “80° C.” Since the types match, the value of the activation parameter is compared to the activation condition to identify that the sole activation condition has been met.

As another non-limiting example, an activation parameter of “100 feet from the Empire State Building” is determined to be of the type “proximity of the MTP to an object.” In this example, there is one persona on the MTP 120, and the persona has two activation conditions required for execution: “within 300 feet of the Empire State Building” and “between 9:00 P.M. and 6:00 A.M.” These activation conditions are determined to be of the types “proximity of the MTP to an object” and “time,” respectively. The activation parameter type is compared to the activation condition types to identify only the type of the activation condition “within 300 feet of the Empire State Building” as matching the type of the activation parameter “100 feet from the Empire State Building.” Since only this condition's type matches the type of the environmental variable, this activation condition is compared to the activation parameter to determine that one of the two conditions has been met. It should be understood that the persona will be activated only when the other activation condition will be met.

According to this example, an additional activation parameter is identified after a while. It is determined that the identified activation parameter which is “10:00 P.M.” is of the type “time.” The activation parameter type is compared to the activation condition types to identify the type of the remaining activation condition as matching the type of the activation parameter. Since the remaining condition type matches the type of the activation parameter, this remaining condition is compared to the activation parameters to determine that the other condition has also been met. The persona is activated respect thereof.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for activating a persona in a multiple-persona mobile technology platform (MTP) comprising:
receiving at least one activation parameter value respective of the MTP;
retrieving at least one activation rule defining at least one activation condition and at least one action to be performed on at least one persona of the multiple-persona of the MTP;
analyzing the at least one received activation parameter value to determine the if the at least one activation condition has been met; and
upon determining that the at least one activation condition has been satisfied, applying the at least one action defined in the satisfied activation condition on the at least one persona.

2. The method of claim 1, wherein the activation parameter is at least one of: an environmental parameter, a system parameter, a hardware parameter, a network parameter, a user behavioral parameter, aggregated data, and time series-based data.

3. The method of claim 2, wherein the environmental parameter is at least one of: a location of the MTP, time information from the location of the MTP, a temperature at the location of the MTP, a proximity of the MTP to at least one object, a level of environmental light at the location of the MTP, and a level of environmental sound at the location of the MTP.

4. The method of claim 2, wherein the network parameter is at least one of: data traffic, connectivity type, current active network connection, settings of the MTP, and wherein the system parameter relates to a status of the software resources of the MTP.

5. The method of claim 2, wherein the hardware parameter is at least one of: the state of a lock screen of the MTP, presence of near-field communication (NFC) signal, device or a pear, network in proximity, and a state of Bluetooth® device.

6. The method of claim 1, wherein the at least one activation rule is set by any one of: information technology (IT) personnel, a security policy, a server external to the MTP, and a user of the MTP.

7. The method of claim 1, wherein each persona in the multiple-persona MTP is defined with a unique set of user preferences associated with a respective persona.

8. The method of claim 1, wherein each persona in the multiple-persona MTP is a user profile defined as part of an operating system supporting a multiple-user feature in the MTP.

9. The method of claim 1, wherein the activation parameter is received from any one of: a global positioning system (GPS), a proximity sensor, a light sensor, a sound sensor, a temperature sensor, a remote server, and an operating system of the MTP.

10. The method of claim 1, wherein the at least one activation condition is any one of: a simple condition, and a compound condition.

11. The method of claim 1, wherein the at least one action is at least one of: switch to the persona, create the persona, activate the persona, download the persona, look the persona, block the persona, enable features of the persona, enable services externally provided to the persona, switch from the persona, destroy the persona, deactivate the persona, delete the persona, unlock the persona, unblock the persona, disable features of the persona, and disable services externally provided to the persona.

12. The method of claim 1, wherein applying the action on at least one persona further comprises:
providing a notification to a user of the MTP about the action.

13. The method of claim 1, further comprising:
checking if more than one activation rule has been satisfied; and
selecting one activation rule from satisfied the one activation rule to process.

14. The method of claim 13, further comprising:
reevaluating the at least one retrieved activation condition has been met, wherein the reevaluating is performed in response to any one on: a predefined trigger, a user request, at predefined time intervals.

15. A non-transitory computer readable medium having stored thereon instructions for causing a processing system to execute the method according to claim 1.

16. A user terminal for activating a persona of a multiple-persona configured on a mobile technology platform (MTP) comprising:
a user interface;
a processing unit; and
a memory, the memory containing instructions that, when executed by the processing unit, configure the terminal to:
receive at least one activation parameter value respective of the MTP;
retrieve at least one activation rule defining at least one activation condition and at least one action to be performed on at least one persona of the multiple-persona of the MTP;
analyze the at least one received activation parameter value to determine the if the at least one activation condition has been met; and
upon determination that the at least one activation condition has been satisfied, applying the at least one action defined in the satisfied activation condition on the at least one persona.

17. The user terminal of claim 16, wherein the activation parameter is at least one of: an environmental parameter, a system parameter, a hardware parameter, a network parameter, a user behavioral parameter, aggregated data, and time series-based data.

18. The user terminal of claim 16, wherein each persona in the multiple-persona MTP is defined with a unique set of user preferences associated with a respective persona.

19. The user terminal of claim 16, wherein each persona in the multiple-persona MTP is a user profile defined as part of an operating system supporting a multiple-user feature in the MTP.

20. The user terminal of claim 16, wherein the at least one activation condition is any one of: a simple condition, and a compound condition.

21. The user terminal of claim 16, wherein the at least one action is at least one of: switch to the persona, create the persona, activate the persona, download the persona, look the persona, block the persona, enable features of the persona, enable services externally provided to the persona, switch from the persona, destroy the persona, deactivate the persona, delete the persona, unlock the persona, unblock the persona, disable features of the persona, and disable services externally provided to the persona.

22. The user terminal of claim 16, wherein the terminal is further configured to:
check if more than one activation rule has been satisfied; and
select one activation rule from satisfied the one activation rule to process.

23. The user terminal of claim 22, wherein the terminal is further configured to:
reevaluate the at least one retrieved activation condition has been met, wherein the reevaluation is performed in response to any one on: a predefined trigger, a user request, at predefined time intervals.

24. A server for activating a persona of a multiple-persona configured on a mobile technology platform (MTP) comprising:
a processing unit; and
a memory, the memory containing instructions that, when executed by the processing unit, configure the server to:
receive at least one activation parameter value respective of the MTP;
retrieve at least one activation rule defining at least one activation condition and at least one action to be performed on at least one persona of the multiple-persona of the MTP;
analyze the at least one received activation parameter value to determine the if the at least one activation condition has been met; and
upon determination that the at least one activation condition has been satisfied, enforcing the at least one action defined in the satisfied activation condition on the at least one persona.

25. The server of claim 24, wherein the activation parameter is at least one of: an environmental parameter, a system parameter, a hardware parameter, a network parameter, a user behavioral parameter, aggregated data, and time series-based data.

26. The server of claim 24, wherein each persona in the multiple-persona MTP is defined with a unique set of user preferences associated with a respective persona.

27. The server of claim 24, wherein each persona in the multiple-persona MTP is a user profile defined as part of an operating system supporting a multiple-user feature in the MTP.

28. The server of claim 24, wherein the at least one activation condition is any one of: a simple condition, and a compound condition.

29. The server of claim 24, wherein the at least one action is at least one of: switch to the persona, create the persona, activate the persona, download the persona, look the persona, block the persona, enable features of the persona, enable services externally provided to the persona, switch from the persona, destroy the persona, deactivate the persona, delete the persona, unlock the persona, unblock the persona, disable features of the persona, and disable services externally provided to the persona.

30. The server of claim 24, wherein the server is further configured to:
check if more than one activation rule has been satisfied; and
select one activation rule from satisfied the one activation rule to process.

31. The server of claim 30, wherein the server is further configured to:
reevaluate the at least one retrieved activation condition has been met, wherein the reevaluation is performed in response to any one on: a predefined trigger, a user request, at predefined time intervals.
